(19) United States
(12) Patent Application Publication
(10) Pub. No.: US 2016/0123418 A1
(43) Pub. Date: May 5, 2016

(54) BRAKE SYSTEM WITH ACTUATION ASSIST

(71) Applicant: GM GLOBAL TECHNOLOGY OPERATIONS LLC, Detroit, MI (US)

(72) Inventors: Joseph K. Moore, Whitby (CA); David Begleiter, Toronto (CA); Veit Held, Bensheim (DE)

(21) Appl. No.: 14/527,053

(22) Filed: Oct. 29, 2014

(51) Int. Cl. F16D 65/18; F16D 55/226

(52) U.S. Cl. CPC F16D 65/18; F16D 55/226; F16D 2121/04

(57) ABSTRACT

A wheel braking system includes a fluid source connected to an actuator that applies a force to a friction element for retarding rotation of the wheel. The braking system also includes a hydraulic circuit that has a first fluid passage providing direct communication between the fluid source and the actuator and a second fluid passage in communication with the first passage. The second fluid passage has a first portion and a second portion and includes a reciprocating piston assembly with a first piston fixed to a second piston for selectively amplifying a volume of the pressurized fluid received by the actuator. The first portion of the second passage is in fluid communication with the first piston and the second portion is in fluid communication with the second piston. The first piston has a first diameter and the second piston has a second diameter that is greater than the first diameter.

### TECHNICAL FIELD

The present disclosure relates to a brake system for a vehicle with an actuation assist feature.

### BACKGROUND

A brake is typically a mechanical device designed to inhibit motion. Brakes commonly use friction to convert kinetic energy into heat, though other methods of energy conversion may be employed. For example, regenerative braking converts much of the kinetic energy to electric energy, which may be stored for later use.

On vehicles, braking systems are employed to apply a retarding force, typically via frictional elements at the vehicle's rotating axles or wheels, to inhibit vehicle motion. Friction brakes often include stationary shoes or pads that are lined with friction material and configured to be engaged with a rotating wear surface, such as a rotor or a drum. Common configurations include shoes that contact to rub on the outside of a rotating drum, commonly called a “band brake”, a rotating drum with shoes that expand to rub the inside of a drum, commonly called a “drum brake”, and pads that pinch a rotating disc, commonly called a “disc brake”.

Modern vehicles typically use a hydraulic fluid channeled through hydraulic passages or lines to apply a force to the aforementioned shoes or pads and press them against the respective rotating disc or drum, which slows the disc or drum and its attendant wheel. As such, application of brakes in a vehicle is largely dependent on the rate and efficiency with which such a working fluid can be displaced and pressurized in the brake system's hydraulic lines.

### SUMMARY

A braking system for retarding rotation of a wheel includes a rotor that rotates synchronously with the wheel, a fluid source configured to supply a pressurized fluid, an actuator configured to receive the pressurized fluid from the fluid source and generate an actuator force. The braking system also includes a friction element configured to be selectively engaged with the rotor by the actuator force to thereby retard rotation of the wheel. The braking system additionally includes a hydraulic circuit configured to provide fluid communication between the fluid source and the actuator. The hydraulic circuit provides actuation assist in the braking system.

The hydraulic circuit includes a first fluid passage providing direct fluid communication between the fluid source and the actuator, and configured to transmit the actuator force from the fluid source to the friction element. The hydraulic circuit also includes a second fluid passage having a first portion and a second portion, wherein each portion is in fluid communication with the first fluid passage. The hydraulic circuit additionally includes a reciprocating piston assembly arranged inside the second fluid passage. The piston assembly has a first piston fixed to a second piston and configured to selectively amplify a volume of the pressurized fluid received by the actuator for rapid engagement of the friction element with the rotor. The first portion of the second fluid passage is in fluid communication with the first piston and the second portion of the second fluid passage is in fluid communication with the second piston. The first piston is defined by a first diameter and the second piston is defined by a second diameter that is greater than the first diameter.

A ratio of the second diameter to the first diameter may define an amplification factor for the volume of the pressurized fluid received by the actuator.

The braking system may additionally include a spring element. The spring element may be configured to store energy when the pressurized fluid is supplied by the fluid source in a first mode of operation of the braking system and release the stored energy to assist disengagement of the friction element from the rotor when the actuator ceases to generate the actuator force in a second mode of operation of the braking system. The spring element may be arranged in direct contact with the second piston.

The braking system may additionally include a flow control valve arranged at a junction between the first fluid passage and the second portion of the second fluid passage. The flow control valve may be configured to selectively block fluid communication between the second portion of the second fluid passage and the first fluid passage via a closed position in a third mode of operation of the braking system. The flow control valve may also be configured to facilitate fluid communication between the second portion of the second fluid passage and the first fluid passage via an opened position in each of the first and second modes of operation of the braking system.

The flow control valve may have a default closed position and is also configured to be at least partially opened for bleeding the hydraulic circuit to purge air therefrom.

The second piston may be configured to accumulate at least a portion of the pressurized fluid when the actuator ceases to generate the actuator force in the second mode of operation of the braking system and release the at least a portion of the fluid when the pressurized fluid is supplied by the fluid source in the first mode of operation of the braking system.

The braking system may also include a limit switch arranged in electrical communication with the flow control valve. The limit switch may also be configured to detect a position of the piston assembly inside the second fluid passage and select a position for the flow control valve in response to the detected position of the piston assembly.

The limit switch may be configured to open the flow control valve in each of the first and second modes of operation of the braking system, and close the flow control valve in the third mode of operation of the braking system.

The first piston and the second piston may be maintained in a spaced relationship via a connecting element. The connecting element may include a feature configured to communicate the position of the piston assembly to the limit switch.

The above-disclosed braking system may be employed in a motor vehicle.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic illustration of a motor vehicle having a braking system according to the disclosure.

FIG. 2 is a schematic perspective view of a representative suspension corner of the vehicle shown in FIG. 1.

FIG. 3 is a schematic illustration of the braking system shown in FIG. 1, wherein the braking system includes a hydraulic circuit depicted in a first mode of operation of the braking system according to the disclosure.

FIG. 4 is a schematic illustration of the braking system shown in FIG. 1, wherein the braking system includes a hydraulic circuit depicted in a second mode of operation of the braking system according to the disclosure.

FIG. 5 is a schematic illustration of the braking system shown in FIG. 1, wherein the braking system includes a hydraulic circuit depicted in a third mode of operation of the braking system according to the disclosure.

### DETAILED DESCRIPTION

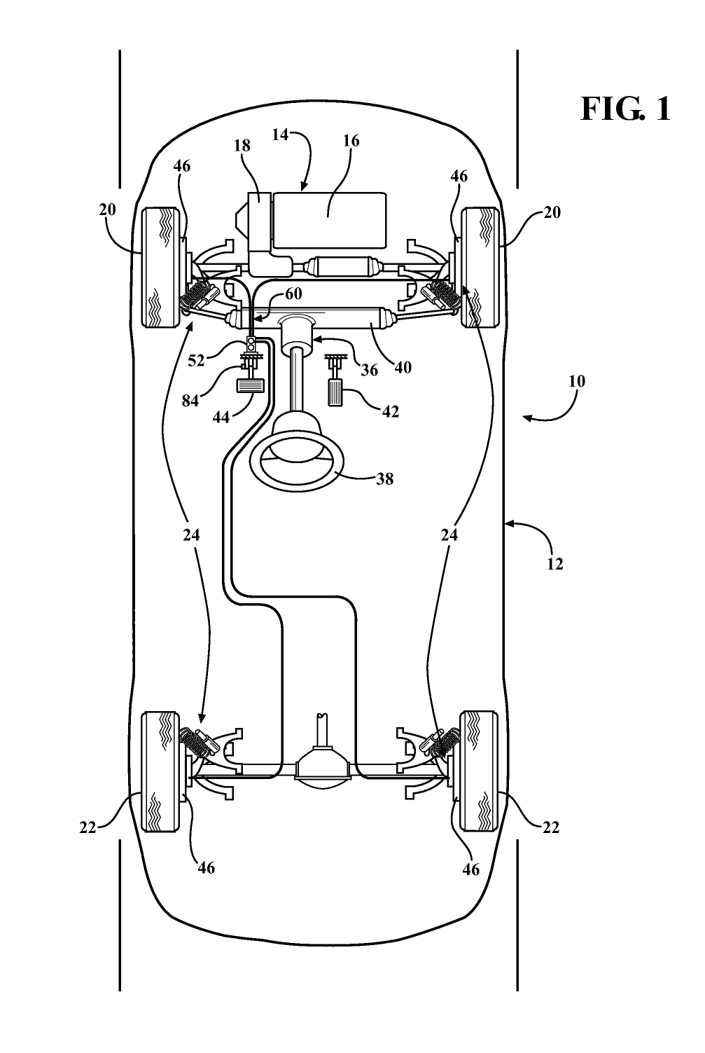

Referring to the drawings, wherein like reference numbers refer to like components, FIG. 1 shows a schematic view of a motor vehicle 10 which includes a vehicle body 12. The vehicle 10 also includes a powertrain 14 configured to propel the vehicle. As shown in FIG. 1, the powertrain 14 includes an engine 16 and a transmission 18. The powertrain 14 may also include one or more motor/generators as well as a fuel cell, neither of which are shown, but a powertrain configuration employing such devices is appreciated by those skilled in the art. Generally, the vehicle 10 also includes an energy storage device (not shown), such as one or more batteries, configured to accept electric charge and supply electric current to operate various vehicle systems.

The vehicle 10 also includes a plurality of road wheels that include front wheels 20 and rear wheels 22. Although four wheels, i.e., a pair of front wheels 20 and a pair of rear wheels 22, are shown in FIG. 1, a vehicle with fewer or greater number of wheels is also envisioned. As shown, a vehicle suspension system 24 operatively connects the body 12 to the front and rear wheels 20, 22 for maintaining contact between the wheels and a road surface, and for maintaining handling of the vehicle. Although in FIG. 1 the suspension system 24 is shown to include upper and lower control arms along with respective springs and dampers, other configurations of the suspension system 24 are similarly envisioned.

As shown in FIG. 1, a vehicle steering system 36 is operatively connected to the front wheels 20 for steering the vehicle 10. The steering system 36 includes a steering wheel 38 that is operatively connected to the wheels 20 via a steering rack 40. The steering wheel 38 is arranged inside the passenger compartment of the vehicle 10, such that an operator of the vehicle may command the vehicle to assume a particular direction with respect to the road surface. Additionally, an accelerator pedal 42 and a brake pedal 44 are each positioned inside the passenger compartment of the vehicle 10. The accelerator pedal 42 is operatively connected to the powertrain 14 for commanding propulsion of the vehicle 10, while the brake pedal 44 is operatively connected to a vehicle braking system 46, and each is adapted to be controlled by the operator of the vehicle.

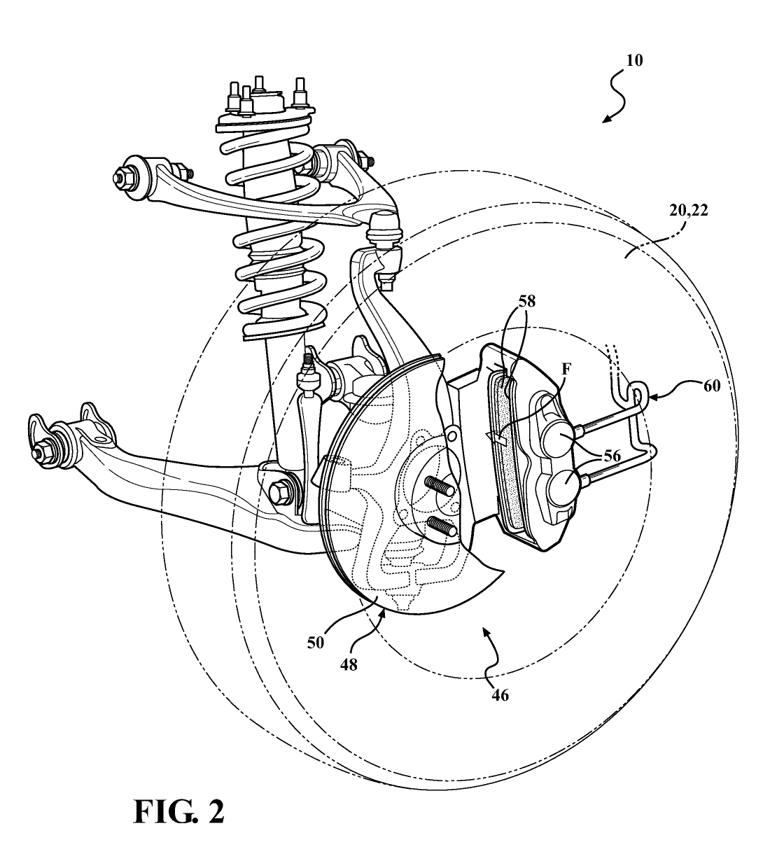

As shown in FIG. 1, the vehicle braking system 46 is operatively connected to the wheels 20, 22 for decelerating the vehicle 10. The braking system 46 includes a friction braking mechanism 48 (shown in FIG. 2) arranged at each of the wheels 20, 22, at what is generally termed a suspension and braking “corner” of the vehicle. Each braking mechanism 48 may be configured as either a disc brake (shown in FIGS. 2-4) or a drum brake (not shown, but understood by those skilled in the art). Each friction braking mechanism 48 includes a rotor 50 configured for synchronous rotation with the respective wheel 20, 22. The braking system 46 also includes a fluid source 52, such as a hydraulic reservoir and/or booster (shown in FIG. 1). The fluid source 52 is configured to supply a pressurized fluid 54 to an actuator 56, such as a hydraulically activated piston arranged in a brake caliper of a disc brake (shown in FIGS. 2-4) or in a foundation of a drum brake (as discussed above), and configured to generate an actuator force F. The actuator force F is generally controlled by an operator of the vehicle 10 via an application of the brake pedal 44.

As shown in FIG. 2, each braking mechanism 48 also includes friction elements 58 configured to be selectively engaged with the rotor 50 by the actuator force F, and thereby retard rotation of the respective wheel 20, 22. The friction element 58 is typically called a “brake pad” or “brake shoe”. As shown in FIG. 2, if the braking mechanism 48 is configured as a disc brake, the rotor 50 is configured as a disc rotor and the friction element 58 is correspondingly configured as a disc brake pad. In the event the braking mechanism 48 is configured as a drum brake, the rotor 50 is configured as a brake drum and the friction element 58 is correspondingly configured as a drum brake shoe. Although the remainder of the disclosure deals specifically with the disc brake configuration of the friction braking mechanism 48, those skilled in the art will recognize that the disclosure is equally applicable to that of a drum brake.

The braking system 46 also includes a hydraulic circuit 60 configured to provide fluid communication between the fluid source 52 and the actuator 56. In other words, the hydraulic circuit 60 transfers a volume of the pressurized fluid 54 from the fluid source 52 to the actuator 56 to engage the friction element 58 with the rotor 50 upon application of the brake pedal 44. The hydraulic circuit 60 includes a first fluid passage 62 and a second fluid passage 64. The first fluid passage 62 provides direct fluid communication between the fluid source 52 and the actuator 56. The second fluid passage 64 includes a first portion 64A and a second portion 64B, wherein each portion 64A and 64B is in fluid communication with the first fluid passage 62.

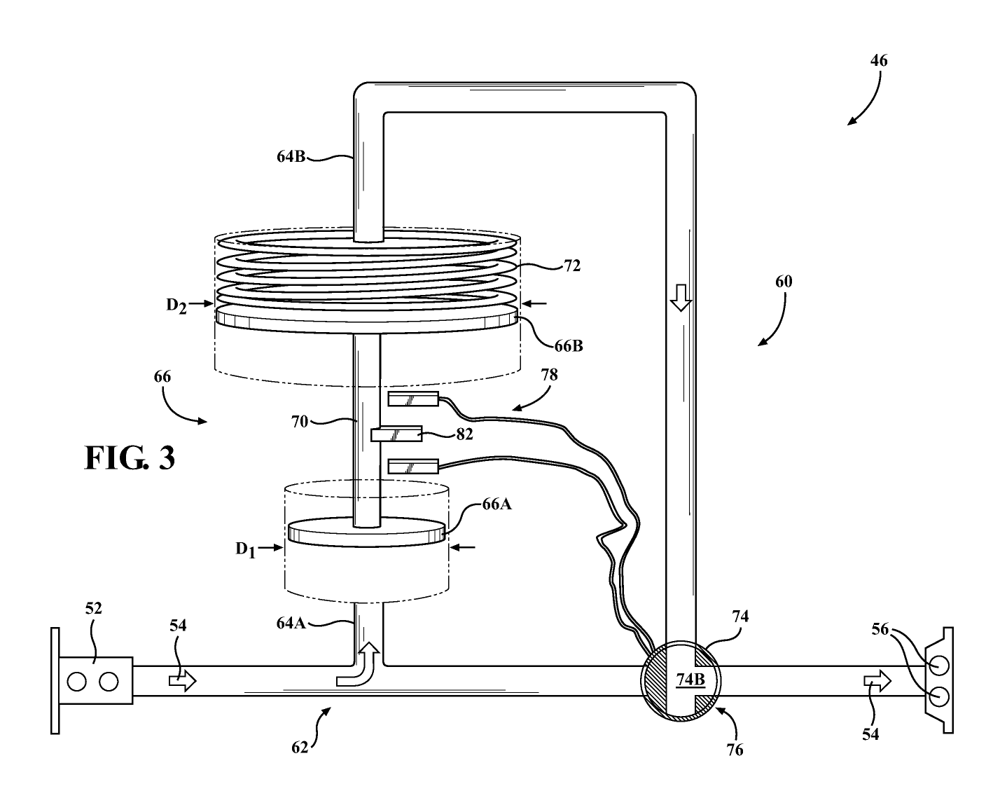

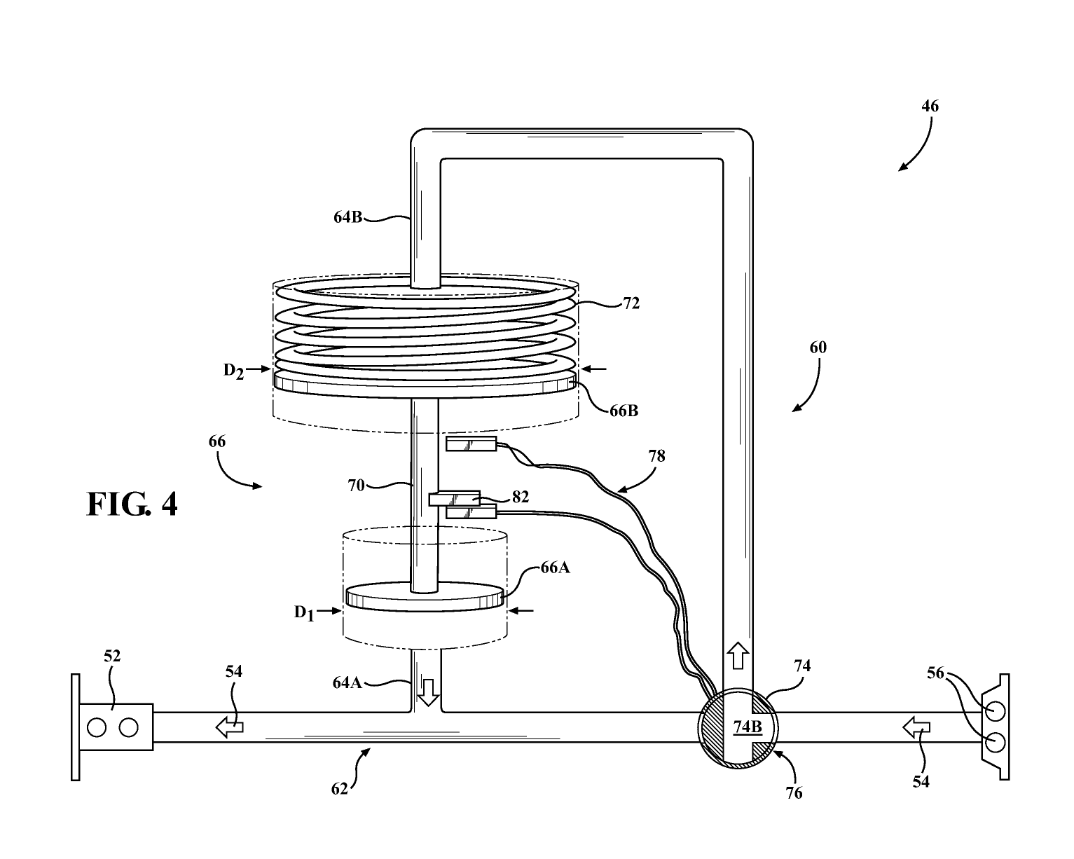

As shown in FIGS. 3-4, the hydraulic circuit 60 additionally includes a reciprocating piston assembly 66 arranged inside the second fluid passage 64. The piston assembly 66 includes a first piston 66A fixed to a second piston 66B, and is configured to selectively amplify the volume of the pressurized fluid 54 received by the actuator 56 for rapid engagement of the friction element 58 with the rotor 50. As employed herein, the volume of the pressurized fluid 54 is amplified when the volume actually received by the actuator 56 upon application of the brake pedal 44 is increased via the action of the reciprocating piston assembly 66 as compared with the volume of the pressurized fluid that would otherwise be delivered to the actuator through the first fluid passage 62. Correspondingly, the term “rapid engagement” denotes a decreased amount of time required for the friction element 58 to come into contact with the rotor 50 upon application of the brake pedal 44 when actuated through the second fluid passage 64, as compared to the amount of time required through the first fluid passage 62.

The first piston 66A and the second piston 66B may be maintained in a spaced relationship via a connecting element or rod 70. The first portion 64A of the second fluid passage 64 is in fluid communication with the first piston 66A and the second portion 64B of the second fluid passage is in fluid communication with the second piston 66B. As shown in FIGS. 3-4, the first piston 66A is defined by a first diameter D₁ and the second piston 66B is defined by a second diameter D₂. The first diameter D₁ is smaller than the second diameter D₂. A ratio 68 of the second diameter D₂ to the first diameter D₁ defines an amplification factor F_{A} for the volume of the pressurized fluid 54 received by the actuator 56. The piston assembly 66 provides actuation assist in the braking system 46 via the amplification factor F_{A}, as will be described in detail below.

A spring element 72 is arranged inside the second fluid passage 64 and configured to store energy from the pressurized fluid 54 when the fluid is supplied by the fluid source 52 in a first mode of operation (shown in FIG. 3) of the braking system 46. The spring element 72 is also configured to release the stored energy to assist disengagement of the friction element 58 from the rotor 50 when the actuator 56 ceases to generate the actuator force F in a second mode of operation (shown in FIG. 4) of the braking system 46. In the process of assisting disengagement of the friction element 58 from the rotor 50, the spring element 72 additionally facilitates rapid disengagement, i.e., quicker pull back, of the friction element 58 from the rotor 50 when operator of the vehicle 10 initially ceases to apply the brake pedal 44. As shown in FIGS. 2-4, the spring element 72 may be arranged in direct contact with the second piston 66B such that the spring exerts a force directly onto the second piston.

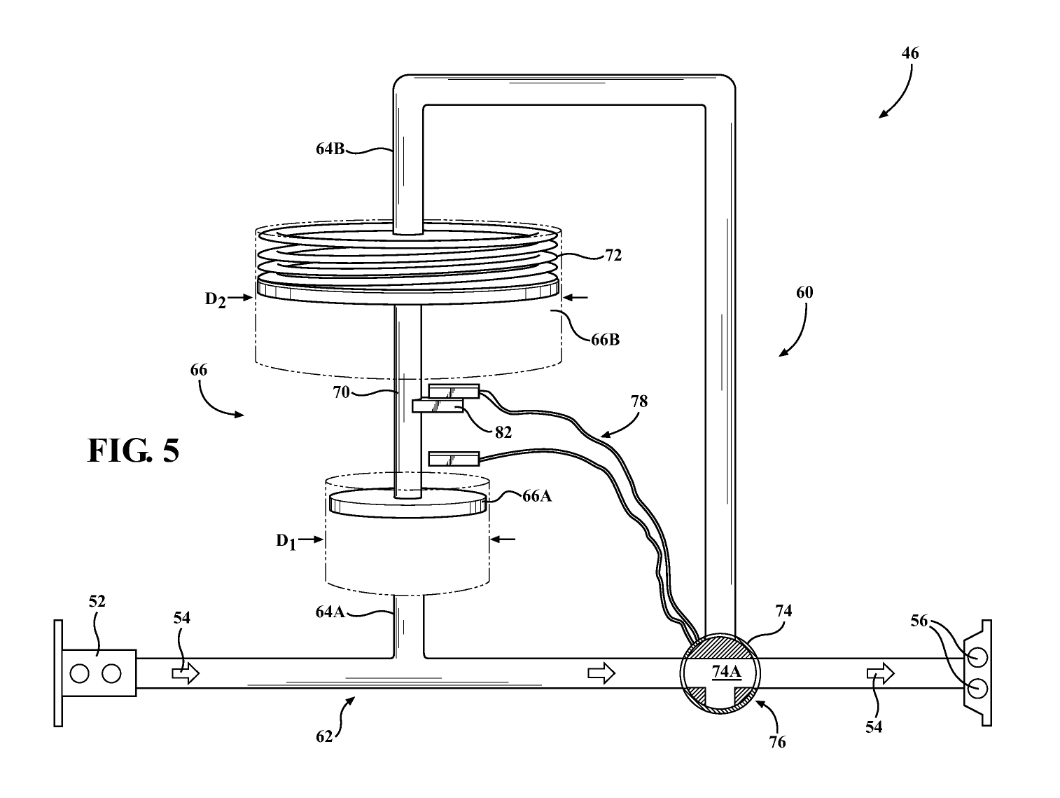

A flow control valve 74 is arranged at a junction 76 between the first fluid passage 62 and the second portion 64B of the second fluid passage 64. The flow control valve 74 is configured to selectively block fluid communication between the second portion 64B of the second fluid passage 64 and the first fluid passage 62 via a closed position 74A or state in a third mode of operation (shown in FIG. 5) of the braking system 46. The flow control valve 74 is also configured to facilitate fluid communication between the second portion 64B of the second fluid passage 64 and the first fluid passage 62 via an opened position 74B in each of the first and second modes of operation of the braking system 46. The closed position 74A may be set as a default state for the flow control valve 74. Setting the closed position 74A as the default position of the flow control valve 74 may be useful in order to maintain a fail-safe operation for the braking system 46. Additionally, the flow control valve 74 may be regulated to a fully open position 74B or to an intermediate, i.e., partially-open, position (not shown), in order to facilitate bleeding of the hydraulic circuit 60 for purging air therefrom.

The second piston 66B is configured to accumulate at least a portion of the pressurized fluid 54 when the actuator 56 initially ceases to generate the actuator force F in the second mode of operation of the braking system 46. Additionally, the second piston 66B is configured to release at least some of the accumulated fluid as the fluid source 52 commences to supply the pressurized fluid 54 in the first mode of operation of the braking system 46. Additionally, in the second mode of operation (shown in FIG. 4) of the braking system 46, the flow control valve 74 would initially start out in the closed position 74A until the brake pedal 44 is completely released. Following the complete release of the brake pedal 44, the control valve 74 would shift to the open position 74B, thus permitting the spring element 72 to release the energy stored by the reciprocating piston assembly 66 and facilitate rapid disengagement of the friction element 58 from the rotor 50.

The braking system 46 may additionally include a limit switch 78. When present, the limit switch 78 is arranged in electrical communication with the flow valve 74 and configured to detect a position of the piston assembly 66 inside the second fluid passage 64. The limit switch 78 can be additionally configured to communicate the detected position to the flow control valve 74 to thereby select an appropriate position for the flow control valve in response to the detected position of the piston assembly 66. Position for the flow control valve 74 may also be selected in response to a predetermined magnitude of the hydraulic apply pressure (P_{Apply}) generated at the fluid source 52 or a signal from a brake apply switch 84 positioned at the brake pedal (shown in FIG. 1).

The limit switch 78 may be configured to open the flow control valve 74 in each of the first and second modes of operation of the braking system 46. Additionally, the limit switch 78 may be configured to close the flow control valve 74 in the third mode of operation of the braking system 46. The connecting element 70 may include a feature 82 configured to translate with the piston assembly 66 and communicate the position thereof to the limit switch 78.

During operation of the vehicle braking system 46, a volume of the pressurized fluid 54 received (V_{Received}) at each of the wheels 20, 22 during rapid engagement of the respective friction braking mechanism 48 in comparison to the volume of the pressurized fluid initially applied (V_{Apply}) transferred into the first portion 64A of the second fluid passage 64 in response to application of the brake pedal 44 is defined by the mathematical relationship:

V_{Received}=(D₂/D₁)²×V_{Apply}

Additionally, as a result of the ratio 68 of the second diameter D₂ to the first diameter D₁, hydraulic pressure received (P_{Received}) at each of the wheels 20, 22 is initially reduced during rapid engagement of the respective friction braking mechanism 48 in comparison to the hydraulic pressure initially generated or applied (P_{Apply}) according to a mathematical relationship:

P_{Received}=[P_{Apply}×(D₁/D₂)²]−[{(16/π²)×K_{Spring}×V_{apply}}/(D₁²×D₂²)]

The ratio 68 (D₂/D₁) represents the above-described amplification factor F_{A} for the volume of the pressurized fluid 54 received by the actuator 56.

Furthermore, a retraction force (F_{Retraction}) for the respective friction braking mechanism 48 at each of the wheels 20, 22 during the mechanism's initial disengagement increases according to a mathematical relationship:

F_{Retraction}=[P_{Atm}×(1−D₁²/D₂²)×A_{Piston}]+[(4/πD₂²)×K_{Spring}×(ΔX)×A_{Piston}]

In the above relationships, P_{Apply} represents the pressure of the fluid 54 in the hydraulic circuit 60, P_{Atm} represents the magnitude of atmospheric pressure, the factor A_{Piston} represents total surface area of the actuator(s) 56, such as the piston(s) in the brake caliper described above, the factor K_{Spring} represents the spring factor or rate of the spring element 72, while the factor ΔX represents the linear distance traveled by each of the two pistons 66A and 66B.

Accordingly, the hydraulic circuit 60 provides actuation assist in the braking system 46 of the vehicle 10. During operation of the braking system 46, the hydraulic circuit 60 permits rapid engagement of the friction element 58 with the rotor 50, thereby shortening the time it takes the vehicle to commence braking after the initial application of the brake pedal 44. Additionally, as disclosed, the hydraulic circuit 60 may assist disengagement of the friction element 58 from the rotor 50 following the release of the brake pedal 44.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A braking system for retarding rotation of a wheel, the system comprising:
a rotor configured to rotate synchronously with the wheel;
a fluid source configured to supply a pressurized fluid;
an actuator configured to receive the pressurized fluid from the fluid source and generate an actuator force;
a friction element configured to be selectively engaged with the rotor by the actuator force to thereby retard rotation of the wheel; and
a hydraulic circuit configured to provide fluid communication between the fluid source and the actuator, the hydraulic circuit having:
a first fluid passage providing direct fluid communication between the fluid source and the actuator; and
a second fluid passage having a first portion and a second portion, wherein each of the first and second portions is in fluid communication with the first fluid passage; and
a reciprocating piston assembly arranged inside the second fluid passage and including a first piston fixed to a second piston and configured to selectively amplify a volume of the pressurized fluid received by the actuator to thereby generate rapid engagement of the friction element with the rotor;
wherein:
the first portion of the second fluid passage is in fluid communication with the first piston and the second portion of the second fluid passage is in fluid communication with the second piston; and
the first piston is defined by a first diameter and the second piston is defined by a second diameter that is greater than the first diameter.

2. The braking system according to claim 1, wherein a ratio of the second diameter to the first diameter defines an amplification factor that amplifies the volume of the pressurized fluid received by the actuator.

3. The braking system according to claim 1, further comprising a spring element configured to store energy when the pressurized fluid is supplied by the fluid source in a first mode of operation of the braking system and release the stored energy to assist disengagement of the friction element from the rotor when the actuator ceases to generate the actuator force in a second mode of operation of the braking system.

4. The braking system according to claim 3, wherein the spring element is arranged in direct contact with the second piston.

5. The braking system according to claim 3, further comprising a flow control valve arranged at a junction between the first fluid passage and the second portion of the second fluid passage, wherein the flow control valve is configured to selectively block fluid communication between the second portion of the second fluid passage and the first fluid passage via a closed position in a third mode of operation of the braking system and facilitate fluid communication between the second portion of the second fluid passage and the first fluid passage via an opened position in each of the first and second modes of operation of the braking system.

6. The braking system according to claim 5, wherein the flow control valve has a default closed position and is also configured to be at least partially opened for bleeding the hydraulic circuit to purge air therefrom.

7. The braking system according to claim 5, wherein the second piston is configured to accumulate a portion of the pressurized fluid when the actuator ceases to generate the actuator force in the second mode of system operation and release the portion of the fluid when the pressurized fluid is supplied by the fluid source in the first mode of system operation.

8. The braking system according to claim 5, further comprising a limit switch arranged in electrical communication with the flow control valve and configured to detect a position of the piston assembly inside the second fluid passage and select a position for the flow control valve in response to the detected position of the piston assembly.

9. The braking system according to claim 8, wherein the limit switch is configured to:
open the flow control valve in each of the first and second modes of system operation; and
close the flow control valve in the third mode of system operation.

10. The braking system according to claim 8, wherein the first piston and the second piston are maintained in a spaced relationship via a connecting element, and wherein the connecting element includes a feature configured to communicate the position of the piston assembly to the limit switch.

11. A motor vehicle comprising:
a road wheel;
an actuator; and
a braking system operatively connected to the road wheel for decelerating the vehicle, the braking system including:
a rotor configured to rotate synchronously with the road wheel;
a fluid source configured to supply a pressurized fluid;
an actuator configured to receive the pressurized fluid from the fluid source and generate an actuator force;
a friction element configured to be selectively engaged with the rotor by the actuator force to thereby retard rotation of the road wheel; and
a hydraulic circuit configured to provide fluid communication between the fluid source and the actuator, the hydraulic circuit having:
a first fluid passage providing direct fluid communication between the fluid source and the actuator; and
a second fluid passage having a first portion and a second portion, wherein each of the first and second portions is in fluid communication with the first fluid passage; and
a reciprocating piston assembly arranged inside the second fluid passage and including a first piston fixed to a second piston and configured to selectively amplify a volume of the pressurized fluid received by the actuator to thereby generate rapid engagement of the friction element with the rotor;
wherein:
the first portion of the second fluid passage is in fluid communication with the first piston and the second portion of the second fluid passage is in fluid communication with the second piston; and
the first piston is defined by a first diameter and the second piston is defined by a second diameter that is greater than the first diameter.

12. The motor vehicle according to claim 11, wherein a ratio of the second diameter to the first diameter defines an amplification factor that amplifies the volume of the pressurized fluid received by the actuator.

13. The motor vehicle according to claim 11, further comprising a spring element configured to store energy when the pressurized fluid is supplied by the fluid source in a first mode of operation of the braking system and release the stored energy to assist disengagement of the friction element from the rotor when the actuator ceases to generate the actuator force in a second mode of operation of the braking system.

14. The motor vehicle according to claim 13, wherein the spring element is arranged in direct contact with the second piston.

15. The motor vehicle according to claim 13, further comprising a flow control valve arranged at a junction between the first fluid passage and the second portion of the second fluid passage, wherein the flow control valve is configured to selectively block fluid communication between the second portion of the second fluid passage and the first fluid passage via a closed position in a third mode of operation of the braking system and facilitate fluid communication between the second portion of the second fluid passage and the first fluid passage via an opened position in each of the first and second modes of operation of the braking system.

16. The motor vehicle according to claim 15, wherein the flow control valve has a default closed position and is also configured to be at least partially opened for bleeding the hydraulic circuit to purge air therefrom.

17. The motor vehicle according to claim 15, wherein the second piston is configured to accumulate a portion of the pressurized fluid when the actuator ceases to generate the actuator force in the second mode of operation of the braking system and release the portion of the fluid when the pressurized fluid is supplied by the fluid source in the first mode of operation of the braking system.

18. The motor vehicle according to claim 15, further comprising a limit switch arranged in electrical communication with the flow control valve and configured to detect a position of the piston assembly inside the second fluid passage and select a position for the flow control valve in response to the detected position of the piston assembly.

19. The motor vehicle according to claim 18, wherein the limit switch is configured to:
open the flow control valve in each of the first and second modes of operation of the braking system; and
close the flow control valve in the third mode of operation of the braking system.

20. The motor vehicle according to claim 18, wherein the first piston and the second piston are maintained in a spaced relationship via a connecting element, and wherein the connecting element includes a feature configured to communicate the position of the piston assembly to the limit switch.
